(19) United States
(12) Patent Application Publication
(10) Pub. No.: US 2004/0130139 A1
(43) Pub. Date: Jul. 8, 2004

(54) COOKING EASEL

(76) Inventor: Katherine Scott Reising, Milwaukee, WI (US)

Correspondence Address: WILDMAN, HARROLD, ALLEN & DIXON, 225 WEST WACKER DRIVE, CHICAGO, IL, 60606, US

(21) Appl. No.: 10/337,682

(22) Filed: Jan. 7, 2003

(51) Int. Cl. B42D 3/00

(52) U.S. Cl. 281/33

(57) ABSTRACT

This invention relates to a cookbook which can be positioned on a support surface. The cookbook is made of three sidewalls which form a generally triangular formation which can stand on the support surface. A plurality of sheets containing food recipe data are positioned to overlie one of the sidewalls.

### FIELD

This invention relates generally to cookbooks, and more specifically to a cookbook easel that can stand on a surface and display food recipe data.

### BACKGROUND

Cookbooks are typically displayed horizontally upon a surface, such as a kitchen counter. Problems arise when a cook wishes to refer to a food recipe while he or she is cooking. Because traditional cookbooks lie flat horizontally on a surface, a user cannot easily see a recipe in the book without standing very close to it and by looking down or propping it up. Problems also arise in storing and transporting traditional cookbooks when the user is finished referring to them. Traditional cookbooks are often bulky, making them difficult to store and difficult to move around. Thus, a cookbook apparatus which can stand on a surface to allow a cook to easily refer to recipe data which can be easily stored and transported would be advantageous to the culinary world.

### SUMMARY

This invention involves a cookbook apparatus which can be positioned in a generally triangular fashion on a support surface, such as a kitchen counter. The cookbook is comprised of at least three sidewalls, with one of the sidewalls forming a base which can be positioned on the support surface, and two opposing sidewalls positioned on opposing sides of the base. Each opposing sidewall is connected to the base by a hinge. The base itself contains a hinge positioned parallel to the opposing sidewalls which allows the adjustment distance between the hinges which connect the opposing sidewalls. Sheets with food recipes are positioned to overlie one another on the surface of one of the sidewalls, allowing the user to easily view the recipes.

### BRIEF DESCRIPTION OF THE DRAWINGS

The qualities and advantages of the Cookbook Easel Apparatus disclosed in the present invention will be readily apparent if the following detailed description is read in conjunction with the accompanying drawings.

FIG. 1 is a perspective view of one example of a cookbook easel apparatus made in accordance with the present invention.

FIG. 2 is a top perspective view of the cookbook easel apparatus of FIG. 1.

FIG. 3 is an underneath perspective view of the cookbook easel apparatus of FIG. 1.

FIG. 4 is a frontal perspective view of the cookbook easel apparatus of FIG. 1.

FIG. 5 is a side perspective of the cookbook easel apparatus of FIG. 1.

FIG. 6 is a frontal perspective view of cookbook recipe sheets enclosed in the cookbook easel apparatus of FIG. 1.

FIG. 7 illustrates a hinge which allows the adjustment of distance between opposing sidewalls in the cookbook easel apparatus of FIG. 1.

### DETAILED DESCRIPTION OF THE INVENTION

A detailed description of one example of a cookbook easel apparatus is now provided for explanatory purposes.

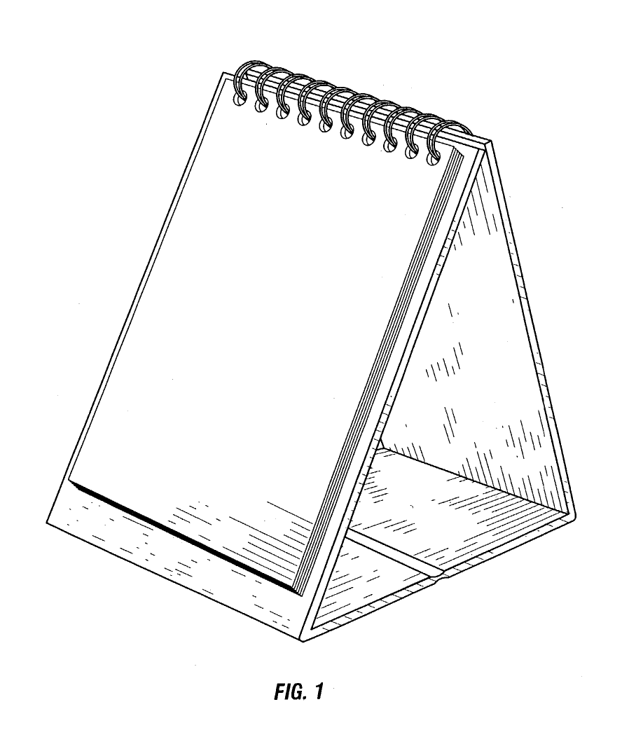

Referring to FIG. 1, a cookbook easel apparatus 10 is capable of being positioned in a generally triangular formation on a support surface 12. The cookbook easel in one example comprises at least three sidewalls 14, a hinge 16, and one or more overlying sheets 18.

One of the sidewalls 14 forms base 20. Base 20 is capable of being positioned on support surface 12. Two opposing sidewalls 22, 24 are positioned on opposite sides of base 20. Opposing sidewalls 22, 24 are connected to base 20 by hinges 26, 28. Hinges 26, 28 in one example are connected integrally to base 20 and to opposing sidewalls 22,24. All three sidewalls can be made from a number of different materials, including, but not limited to, cardboard and molded plastic.

Referring further to FIG. 1, base 20 includes hinge 30. Hinge 30 allows for the adjustment of a distance between hinges 26, 28, which connect base 20 to opposing sidewalls 22, 24.

Still referring to FIG. 1, hinge 16 in one example comprises at least one ring member 32. Hinge 16 engages and connects top portions 34 of opposing sidewalls 22, 24 to each other. Hinge 16 also engages and connects sheets 18 to opposing sidewalls 22, 24.

Sheets 18 in one example contain food recipe data. Sheets 18 are positioned to overlie another on a surface of one of the opposing sidewalls 22, 24. Hinge 16 in one example can open and close, so that one or more of sheets 18 can be added or removed from easel 10.

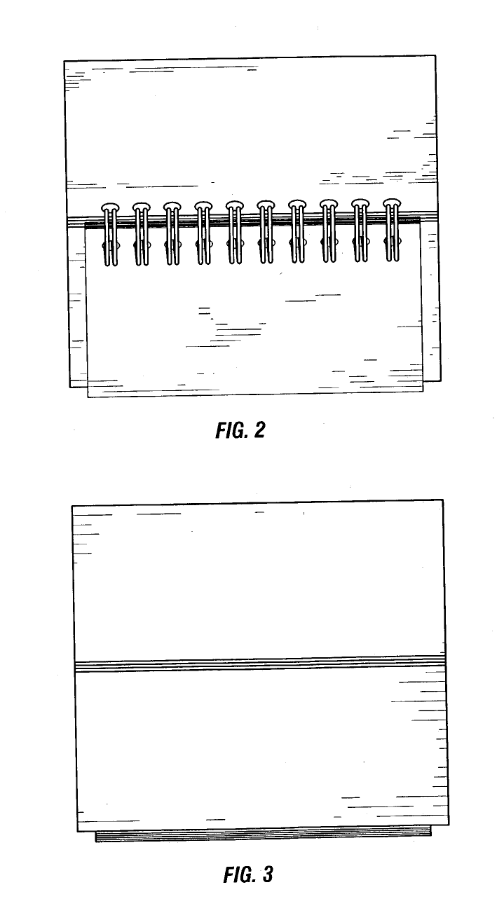

Referring to FIG. 2, the top portions 34 of opposing sidewalls 22, 24 in one example have one or more holes 36. Holes 36 can be circular, rectangular or a variety of other shapes. Holes 36 engage ring member 32 which connects the opposing sidewalls 22, 24. Ring member 32 in one example is a spiral binding. However, other materials can be used to connect opposing sidewalls 22,24, including but not limited to, clips or perforated binding elements.

Referring to FIG. 3, base 20 contains hinge 30 which is positioned generally parallel to the two opposing sidewalls 22, 24. Hinge 30 extends in one example across the width of base 20 and divides base 20 into two sections 38,40 which in the present example are equal in area although they could be unequal in area. Hinge 30 can be adjusted to change the distance between hinges 26, 28, as is further discussed below.

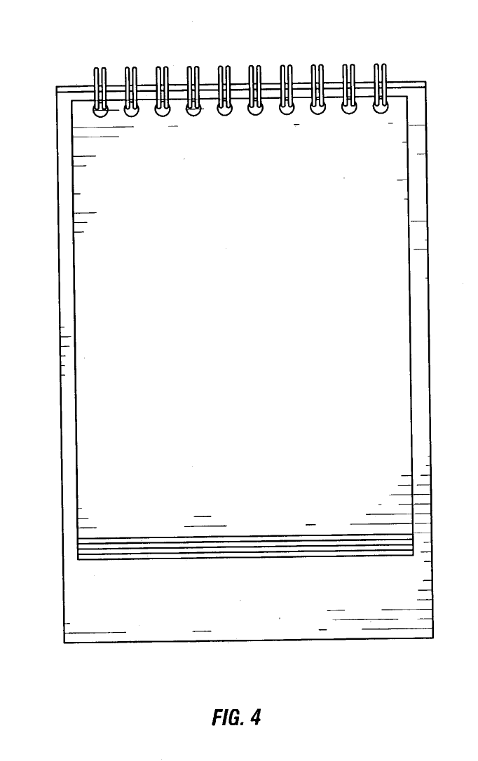

Referring to FIG. 4, in one example the surface of opposing sidewall 24 has a greater dimension than that of sheets 18. However, sheets 18 can also have a dimension equal or greater than the dimension of the opposing sidewall 24.

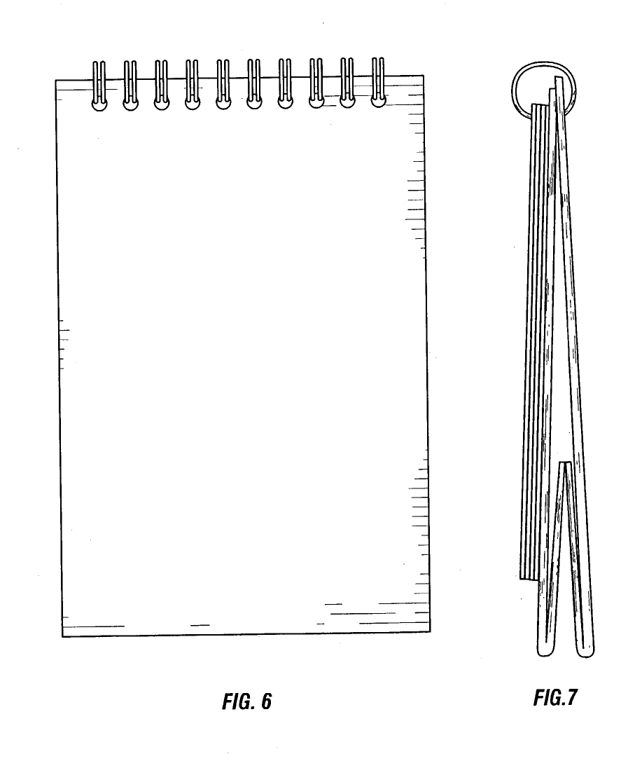

Referring to FIG. 6, sheets 18 contain food recipe data which the user refers to while cooking. Sheets 18 in one example have one or more holes 38 to engage at least one ring member 32. Sheets 18 can have food recipe data on one or both sides of the sheet. Sheets 18 in one example are made from paper, although other materials such as plastic may be used.

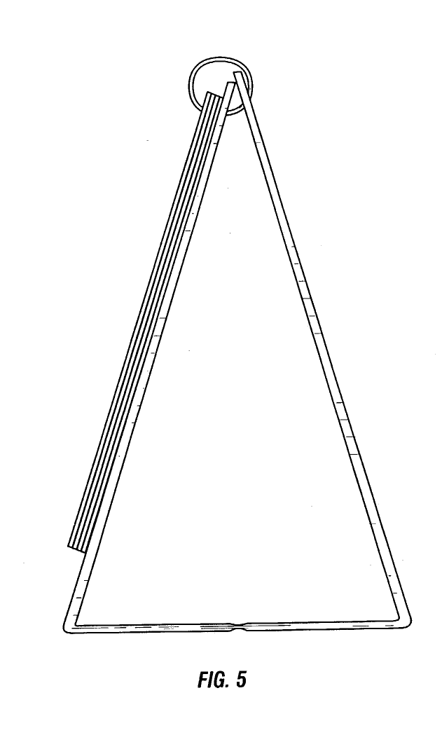

Referring to FIGS. 5 and 7, the distance between hinges 26, 28 can be adjusted by manipulating hinge 30. When hinge 30 lies flat on support surface 12, the hinges 26,28 are at a maximum distance apart and an angle is formed between the opposing sidewalls 22,24 and sections 38, 40 respectively. However, if the user raises hinge 30, the distance between the hinges 26,28 connecting opposing sidewalls 22, 24 decreases, and a more acute angle is formed between the opposing sidewalls and sections 38, 40. This feature is useful because it enables a user to vary the angle of the food recipe data display according to his/her viewing preferences. As a result, the user is able to refer to the food recipe data easily. This feature is also useful because when the distance between the hinges 26,28 connecting the opposing sidewalls is decreased, a user can operate the cookbook apparatus using only a small amount of surface area. Furthermore, this feature also allows a user to easily collapse and store the cookbook.

What is claimed is:

1. An cookbook apparatus, comprising:
a support comprising at least three sidewalls capable of being positioned in generally a triangular formation, wherein said three sidewalls includes one of said sidewalls forming a base capable of being positioned on a support surface and two opposing sidewalls positioned on opposing sides of the base in which each of the opposing sidewalls are connected to the base with a hinge, wherein the base contains another hinge positioned generally parallel to the two opposing sidewalls permitting adjustment of a distance between the hinges which connect the opposing sidewalls to the base;
a plurality of sheets positioned to overlie one another on a surface of at least one of the opposing sidewalls in which food recipe data is positioned on at least one of the sheets; and
an additional hinge connecting a top portion of the opposing sidewalls and engaging a top portion of the plurality of sheets permitting at least one of the sheets to be moved from an overlying position of one of the opposing sidewalls and about the additional hinge to an overlying position of the other opposing sidewall.

2. The cookbook apparatus of claim 1 including the hinges connecting the opposing sidewalls to the base are integral with the base and the opposing sidewalls.

3. The cookbook apparatus of claim 1 including the other hinge is positioned generally equal distance from each of the hinges connecting the opposing sidewalls to the base.

4. The cookbook apparatus of claim 1 including the other hinge is integral with the base.

5. The cookbook apparatus of claim 1 including the additional hinge comprising at least one ring member engaging the top portions of the opposing sidewalls and at least one of the plurality of sheets.

6. The cookbook apparatus of claim 5 including a plurality of spaced apart ring members positioned along the top portion of the opposing sidewalls.

7. The cookbook apparatus of claim 1 including each of the opposing sidewalls have a surface capable of supporting at least one sheet of the plurality of sheets.

8. The cookbook apparatus of claim 7 including the surface of a larger dimension than the at least one sheet of the plurality of sheets.

9. The cookbook apparatus of claim 7 including the surface of each opposing sidewalls is positioned on an outer portion of the triangular formation.

10. The cookbook apparatus of claim 7 including the surface of each of the opposing sidewalls are capable of forming an acute angle with a plane within the support surface with the hinges of the opposing sidewalls positioned at a first distance apart.

11. The cookbook apparatus of claim 10 including the surface of each opposing sidewall capable of forming a more acute angle with the plane with the hinges of the opposing sidewalls positioned at a second distance apart, in which the second distance is less than the first distance.
